(19) United States
(12) Patent Application Publication
(10) Pub. No.: US 2016/0342810 A1
(43) Pub. Date: Nov. 24, 2016

(54) Obtaining Data of Interest From Remote Environmental Sensors

(71) Applicant: Bradford H. Needham, North Plains, OR (US)

(72) Inventor: Bradford H. Needham, North Plains, OR (US)

(21) Appl. No.: 14/361,971

(22) PCT Filed: Dec. 17, 2013
(86) PCT No.: PCT/US13/75799

§ 371 Date: May 30, 2014

(51) Int. Cl. G06F 21/62; H04W 12/08; G06F 1/16; G06F 21/32; G06F 3/01; G06F 3/00

(52) U.S. Cl. CPC G06F 21/6245; G06F 3/017; G06F 3/005; G06F 1/163; G06F 21/32; H04W 12/08

(57) ABSTRACT

A controller associated with an environmental sensor that captures data about an individual controls data capture of the environmental sensor in accordance with a policy of the individual. The controller provides access to the individual to environmental data related to the individual in accordance with the policy. The controller device receives captured data from the environmental sensor, and identifies the individual. The controller accesses a policy associated with the individual that indicates a third party recording policy of the individual, including indicating what environmental information, if any, the individual is interested in receiving from third parties. The controller controls use of the captured data in accordance with the policy, including providing access to the individual to environmental data related to the individual.

### FIELD

Embodiments of the invention are generally related to environmental sensors, and more particularly to policies and protocols for an observed person to obtain data from environmental sensors.

### COPYRIGHT NOTICE/PERMISSION

Portions of the disclosure of this patent document may contain material that is subject to copyright protection. The copyright owner has no objection to the reproduction by anyone of the patent document or the patent disclosure as it appears in the Patent and Trademark Office patent file or records, but otherwise reserves all copyright rights whatsoever. The copyright notice applies to all data as described below, and in the accompanying drawings hereto, as well as to any software described below: Copyright © 2013, Intel Corporation, All Rights Reserved.

### BACKGROUND

There has been a significant increase in the number of sensors that people encounter on a regular basis, such as devices that record audio and/or video. There is a very high likelihood that the number of such sensors will increase dramatically, as surveillance is more common than ever. Additionally, there is an increase in availability and capability of wearable devices. Many wearable devices are capable of detecting and measuring a number of biometric and emotional parameters of the wearer, such as heart rate, breathing, galvanic skin response, and speech affect (emotional content of the wearer's speech). All of that information may be useful and interesting to the wearer. However, there is another set of such parameters, which can be sensed only by external sensors, or sensors not worn by the person being observed. For example, a person's facial expression, body posture, and gestures can be measured only by a camera pointed at the person, whereas wearable devices typically record what is being looked at by the wearer.

Thus, currently there is a great deal of information about a person that is being recorded or measured, and which the person has no control over. The person being observed may have interest in the data, but traditionally it is impractical for the observed individual to obtain the information of interest. Additionally, the recording devices that measure the sensor data (e.g., video, audio, or other information) traditionally have no mechanism to protect the privacy of the person being observed, or even to identify when certain collected data may actually be about someone other than the one that controls the sensor. There are currently no mechanisms that allow negotiation of privacy or other recording policies.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, and/or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an embodiment of an interaction between an observed individual and a sensor.

FIG. 2A is a block diagram of an embodiment of an interaction between an observed individual and a sensor, where the observed individual has a wearable device.

FIG. 2B is a block diagram of an embodiment of an interaction between an observed individual and a sensor, where the sensor is another individual's wearable device.

FIG. 2C is a block diagram of an embodiment of an interaction between wearable devices of two different individuals.

FIG. 3 is a block diagram of an embodiment of a system having an environmental sensor that can capture data about an observed individual within an environment monitored by the sensor.

FIG. 4 is a flow diagram of an embodiment of an example of a policy-based interaction between a sensor and an individual.

FIG. 5 is a flow diagram of an embodiment of a process for interaction between a sensor and an individual that has a third party recording policy.

FIG. 6 is a block diagram of an embodiment of a computing system in which policy-based recording control can be implemented.

FIG. 7 is a block diagram of an embodiment of a mobile device in which policy-based recording control can be implemented.

FIG. 8 is a block diagram of an embodiment of a wearable device in which policy-based recording control can be implemented.

Descriptions of certain details and implementations follow, including a description of the figures, which may depict some or all of the embodiments described below, as well as discussing other potential embodiments or implementations of the inventive concepts presented herein.

### DETAILED DESCRIPTION

As described herein, an observed individual can indicate a recording policy to third party environmental sensors. The recording policy allows an individual to negotiate the type of data recorded about the individual, and how the individual can obtain access to data of interest. A controller associated with an environmental sensor that captures data about the individual controls data capture of the environmental sensor in accordance with the recording policy. The controller provides access to the individual to environmental data related to the individual in accordance with the policy. In operation, the controller device receives captured data from the environmental sensor, and identifies the individual.

Based on identifying the individual, the controller can access the individual's recording policy and determine what environmental information, if any, the individual is interested in receiving from third parties. The controller controls use of the captured data in accordance with the policy, including providing access to the individual to environmental data related to the individual. It will be understood that reference to an “observed individual” refers to an individual who is within a range or within an environment in which a sensor device is capable of capturing data about the individual. An observed individual is not necessary one that is under observance in the sense of intentional surveillance, but rather within an environment in which a third party sensor can capture data about the individual.

It will be understood that an environmental sensor refers to any device capable of collecting data about an individual. An individual can have sensors within a personal wearable device or equipment, and the individual can be observed by third party devices that are under the control of someone other than the observed individual. The sensors can capture raw data or raw media, which is simply the recorded data itself. Some sensors or sensor systems are capable of deriving observations about the individual. For example, a camera can be one example of an environmental sensor that captures pictures of an observed individual. The still images are the raw data. A system could further compute mood or emotional state information of the observed individual based on facial expression, body posture, and/or gestures captured in the pictures. The computed emotional information is a derived observation or derived information.

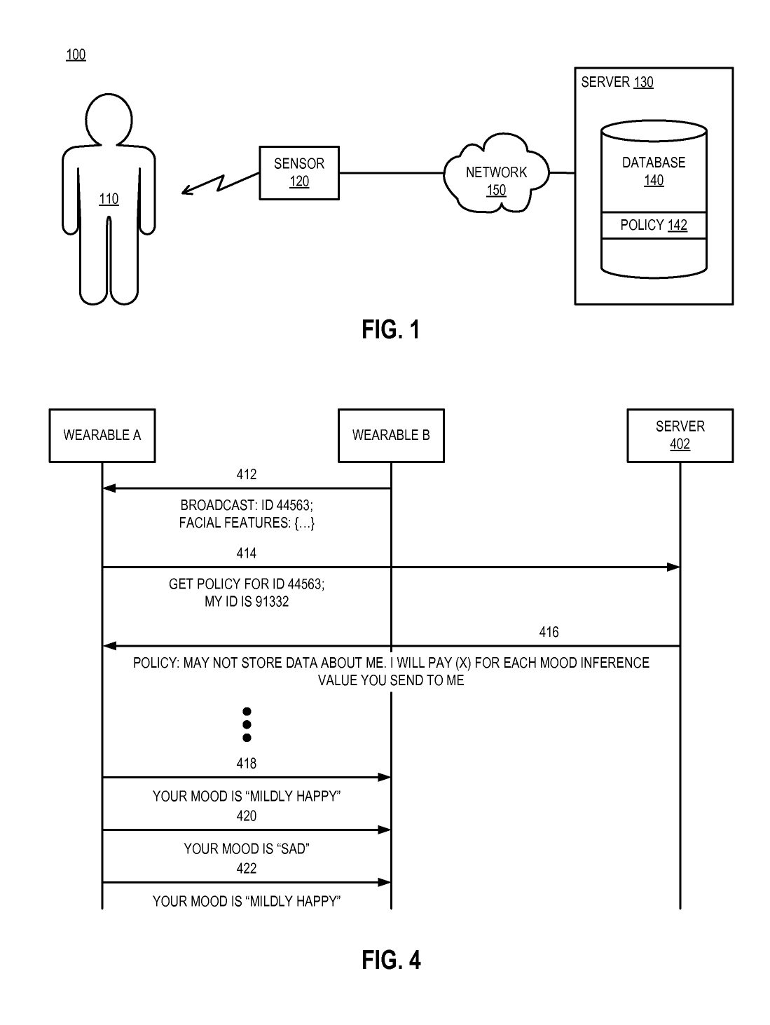

FIG. 1 is a block diagram of an embodiment of an interaction between an observed individual and a sensor. Environment 100 represents any environment in which individual 110 comes within an area where sensor 120 can detect information about individual 110. It will be understood that depending on the type of the sensor (e.g., video, still image capture, voice, infrared, or other) and the environment (the presence of other individuals, interference, background noise or activity, or other conditions), different sensors 120 will have larger or smaller environments.

For purposes of environment 100, sensor 120 is assumed to include computing resources and storage resources for captured data, which can be local to the sensor device, or external to the sensor device. Sensor 120 is connected to network 150, which can be a local area network, wide area network, global network, or a combination. Network 150 allows sensors 120 to access server 130.

Server 130 represents any type of server or access point to database 140. Database 140 includes policy information 142, which is a third party recording policy associated with individual 110. In one embodiment, server 130 represents a “cloud-based” resource through which information is accessed over network 150. Policy 142 identifies or indicates what individual 110 permits and does not permit with respect to third party recording. In one embodiment, the policy can indicate that data about the individual cannot be kept without consent. In one embodiment, the policy can indicate that individual 110 is interested in certain data from third party sources, such as derived information about behaviors or emotional states (e.g., interested in pictures of me when I am smiling). In one embodiment, policy 142 indicates that individual 110 is willing to compensate a third party for certain types of data.

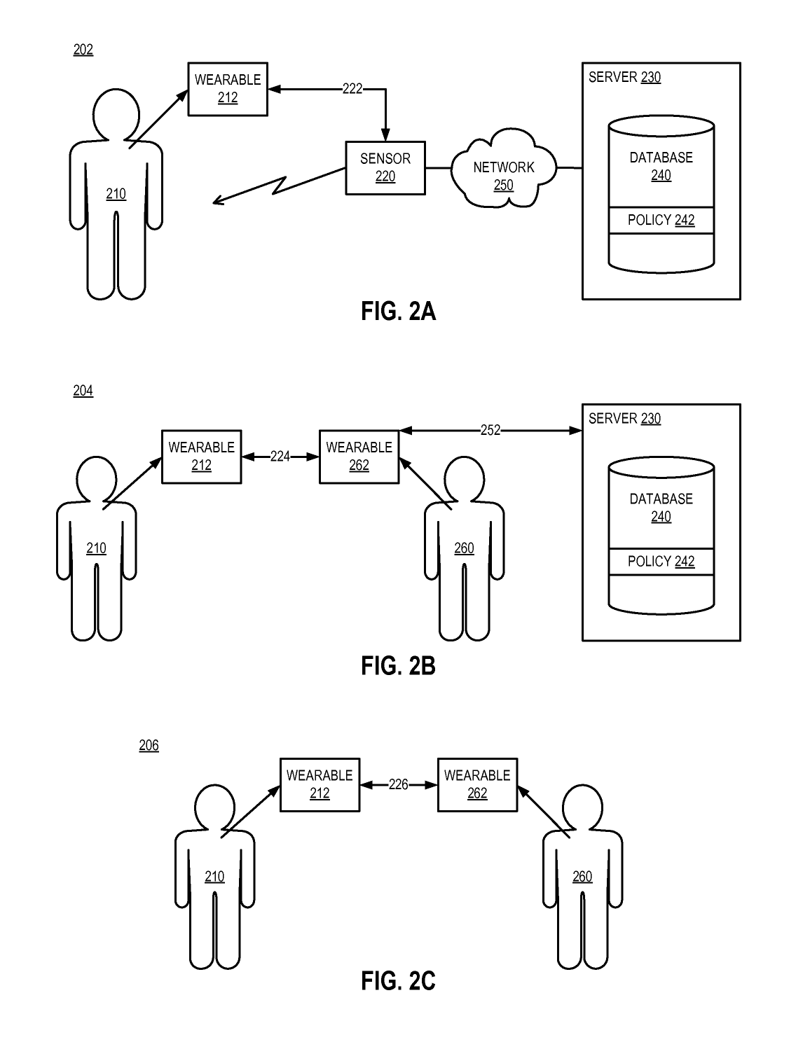

While not specifically shown, sensor includes associated storage (e.g., either local to a sensor system, or remote to a network location) that stores data captured by the sensor. Sensor 120 can manage the storing of the data in accordance with policy 142. Thus, sensor 120 is capable of remotely sensing individual 110, processing the captured data, and communicating that data externally. Sensor 120 is also capable of obtaining policy 142 from database 140 to comply with the policy with respect to individual 110. Thus, sensor 120 is capable of honoring a privacy policy of an observed individual. Sensor 120 can make data available to individual 110 based on policy 142, such as by sending raw data and/or derived observations to individual 110 or storing such raw data and/or derived observations in a location where individual 110 can access the data. Additional interaction scenarios are described in more detail with respect to FIGS. 2A, 2B, and 2C.

In addition to common scenarios where sensor 120 captures audio and/or video or still image data, there are many types of data that sensor 120 can potentially capture. Various biometric data can be sensed remotely, any one or more of which could be captured by different embodiments of sensor 120. Examples include: pulse rate, e.g., as indicated via subtle color changes in facial video; facial affect including facial gestures such as happy, sad, disgusted, fearful, or others, or emotional state as indicated by measuring subtle features changes (e.g., detect change of mood) and/or color changes (e.g., detect blushing); body posture via a depth-sensing camera; level of agitation, e.g., as indicated via blink rate and voice; gaze-tracking, e.g., via infrared (IR) and visible light cameras; or, others.

FIG. 2A is a block diagram of an embodiment of an interaction between an observed individual and a sensor, where the observed individual has a wearable device. Environment 202 can be one example of environment 100 of FIG. 1. Individual 210 is an observed individual with respect to sensor 220. Sensor 220 captures data related to individual 210, and processes the data. In one embodiment, sensor 220 is a wearable or carry-able sensor device or sensor system. Sensor 220 can access server 230 via network 250. Server 230 provides access to database 240, which stores policy 242 associated with individual 210.

As illustrated in environment 100, the observed individual does not necessarily need to have a wearable or carry-able sensor. The observed individual can still have a privacy policy or recording policy in place, which can then be adhered to by the observing sensor. In one embodiment, individual 210 includes wearable device 212, which can include any type of wearable or carry-able sensor or sensor system. In one embodiment, wearable 212 and sensor 220 include communication mechanisms that allow them to exchange messages over channel 222. For example, channel 222 could be an ad hoc WiFi network negotiated between the devices, or a Bluetooth channel between the devices. In general, sensor 220 can make data available to wearable 212 in any type of transfer over channel 222. In one embodiment, sensor 220 can send the data to wearable 212 in a “push” transaction. In one embodiment, wearable 212 can read the data from sensor 220 in a “pull” transaction. Thus, sensor 220 can transfer data to a device of the observed individual.

In one embodiment, exchanges between wearable 212 and sensor 220 can be governed by a protocol (e.g., a protocol that could be adopted for wearable devices). In one embodiment, one of the devices, sensor 220 or wearable 212, detects the other sensor, and initiates a privacy negotiation by providing access to sensor 220 to policy 242. In one embodiment, sensor 220 detects individual 210, and broadcasts a message that wearable 212 receives. Wearable 212 can then reply back to sensor 220 indicating identity of individual 210. As a shorthand, reference can be made herein to an observed individual performing an operation and/or providing information to a sensor or a third party wearable. It will be understood that reference to an observed individual providing information to a third party sensor or wearable refers to a device associated with the observed individual providing the information. Similarly, other operations described may be better understood as a device associated with the observed individual performing the operation.

Sensor 220 can then determine how to manage data captured about individual 210. In one embodiment, sensor 220 obtains policy 242 from database 240 based on identification information provided by wearable 212. In one embodiment, sensor 220 identifies individual 210 based on measured information (e.g., facial recognition data). Sensor 220 can obtain information to use to derive identity from individual 210. Sensor 220 could alternatively obtain information from a database of facial recognition or other biometric marker information from a database. Policy 242 indicates to sensor 220 what information about individual 210 will be stored and/or calculated by sensor 220, and what and how such information can be delivered to individual 210 or otherwise made accessible to individual 210.

In one embodiment, sensor 220 can provide raw information and/or derived information via direct transfer to wearable 212. In one embodiment, sensor 220 can store the data in a network location where individual 210 can access the information. In one embodiment, the exchange over channel 222 can include “payment” by individual 210 for the data provided by sensor 220. Payment can include monetary exchange. Payment can include reciprocity/barter, e.g., “I'll give you your photo from my device if you give me my photo from yours.” In one embodiment, “payment” can include verification of registration with a service that provides access to data. In one embodiment, the negotiation over channel 222 can include privacy requirements, such as “You cannot store photos your camera takes of me, but you can sell me those photos as your camera takes them.”

It will be understood that while photos are mentioned in the above examples, both raw and derived data can be used. Processed data can include mood derived from facial affect, which is in turn derived from live video, medical observations, blushing, affect (e.g., agitation) derived from body posture and gesture, which in turn can be derived from wide-angle color and depth sensitive video, or other information. In addition to video and audio, as mentioned above, sensor 220 can derive information from additional sensors such as infrared sensors to track gaze, ultrasonic proximity sensors to measure how close the individual stands, and/or other sensors. Thus, sensor 220 can capture data of interest to individual 210, which is about or related to individual 210, and which is impractical for individual 210 to capture with first-person sensors.

FIG. 2B is a block diagram of an embodiment of an interaction between an observed individual and a sensor, where the sensor is another individual's wearable device. Environment 204 can be one example of environment 100 of FIG. 1, and can be one example of environment 202 of FIG. 2A. Individual 210 is an observed individual with respect to one or more sensors of wearable 262 of individual 260. While only shown with respect to individual 210 being the observed individual, it will be understood that individual 260 can be an observed individual with respect to wearable 212 of individual 210. Just as wearable 262 can access server 230 via network connection 252 to obtain policy 242 from database 240, in one embodiment, wearable 212 could access server 230 via a network connection to obtain a policy associated with individual 260.

Wearable 212 and wearable 262 can communicate via wireless connection 224, such as a WiFi, personal area network connection, Bluetooth connection, or other connection. In one embodiment, each wearable, and therefore each individual, is associated with a UUID (universal unique identifier), which allows unique identification of the individual/wearable. Thus, connection 224 can allows wearables 212 and 262 to exchange ID information. In one embodiment, in addition to exchanging device identification information, the wearables can also exchange information to specifically identify the individual, such as including facial recognition data in the data exchange.

With wearable 212 and wearable 262, the interaction in environment 204 can proceed in the same manner as what is described above with respect to environment 202. An individual's associated privacy policy or third party recording policy can indicate what information about the individual is permitted to be collected, stored, and transmitted by any other person's sensor (e.g., what wearable 262 can do with data about individual 210). In one embodiment, the policy is a static policy 242. In an alternative embodiment, the policy is dynamic and not necessarily stored on server 230. In one embodiment, the policy can be dependent on the identity of the person accessing the policy. For example, assume that individual 260 is a friend of individual 210. In that case, policy 242 may provide more liberal permissions with respect to what wearable 262 can record, what data can be derived, and how that information can be used or accessed. Assuming that individual 260 is a stranger, policy 242 may be more restrictive (e.g., prohibiting recording or deriving mood information). When both wearable 212 and wearable 262 work in unison, individuals 210 and 260 can obtain more detailed information about their interaction than either could alone with their personal or first person sensors. Thus, if each sensor device or sensor system has access to another person's policy, a policy-based interaction can result in both parties obtaining information from the other.

FIG. 2C is a block diagram of an embodiment of an interaction between wearable devices of two different individuals. Environment 206 can be one example of environment 100 of FIG. 1, and can be one example of environment 202 of FIG. 2A. Environment 206 can be a further refinement of environment 204 of FIG. 2B. Individual 210 is an observed individual with respect to one or more sensors of wearable 262 of individual 260. Individual 260 can be an observed individual with respect to sensors of wearable 212 of individual 210.

As mentioned above, a third party recording policy can be dynamic. Environment 206 illustrates that an exchange can take place without access to an external server. Instead, wearables 212 and 262 for network connection 226 between themselves (which can be the same as connection 224 or 222 described above), and exchange all necessary data to implement a policy-based interaction. More specifically, wearable 212 would communicate identity and identification information for individual 210 to wearable 262. Similarly, wearable 262 would communicate identity and identification information for individual 260 to wearable 212. The wearable devices can also exchange policy information for their respective users, which allows the interaction to proceed in accordance with the policies.

Thus, while individuals 210 and 260 are interacting, wearable 212 can monitor certain information about individual 260 as specified by the policy of individual 260. Similarly, wearable 262 can monitor certain information about individual 210 as specified by the policy of individual 210. Each wearable can provide raw and/or derived data to the other wearable as negotiated by policy.

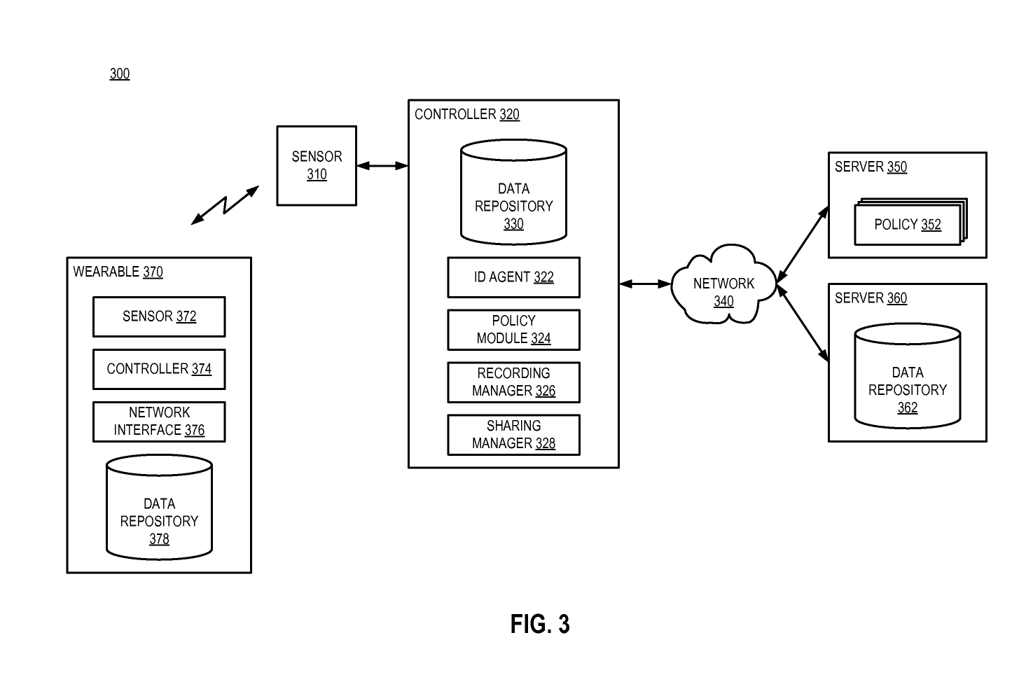

FIG. 3 is a block diagram of an embodiment of a system having an environmental sensor that can capture data about an observed individual within an environment monitored by the sensor. System 300 represents an environment in which a sensor device interacts with a user that has a wearable device. System 300 can be one example of environment 100 of FIG. 1, or system 202 of FIG. 2A. System 300 does not explicitly illustrate the observed individual that is within the environment of sensor 310. Rather, system 300 illustrates certain technical aspects of the interaction environment.

Sensor 310 is any type of sensor described herein, which can be a standalone sensor, or part of wearable device. In previous environments, the sensors were assumed to have components to enable the sensor to communicate over a network (either a network connection to a wearable device of the observed individual, or over a network connection to a server that stores policy information, or both) and to enable the sensor to perform processing on the data captured. In one embodiment, the sensor that captures the data can be considered separate from the processing resources that perform the processing operations and engage in network communication. Sensor 310 represents the data capturing functions of sensor devices. In one embodiment, sensor 310 is part of a sensor system that has processing resources. In one embodiment, the processing resources are shared with other sensor devices.

Controller 320 represents the processing resources that processes the raw data captured by sensor 310. In one embodiment, controller 320 and sensor 310 are separate parts of the same device. In one embodiment, controller 320 stores data repository 330, which can be a short-term or a longer-term storage device to store data captured via sensor 310. In one embodiment, repository 330 stores data only temporarily to process it. In one embodiment, controller 320 stores raw data and/or derived information in repository 330 for transmission to an observed individual or to a location where the observed individual can access the data. It will be understood that repository 330 can be implemented outside of controller 320, and is a storage resource to which controller 320 has local access, such as a bus connection.

Controller 320 can include one or more functional elements. The functional elements can be implemented in hardware and/or software components, or a combination of hardware and software components. In one embodiment, controller 320 is implemented as a processor unit that executes firmware logic. The processor unit can be any type of microprocessor, microcontroller, central processing unit, or other processing device. It will be understood that controller 320 represents the logic or controller that performs the operations related to the third party recording policy of the observed individual. Thus, when the sensor or sensor system performs operations related to processing data, identifying the observed individual, or providing access to the sensor data, processor 320 enables the operations.

In one embodiment, controller 320 includes ID agent 322, which enables controller 320 to identify an observed individual. ID agent 322 can identify an individual by obtaining an identifier from the individual (e.g., a UUID), facial recognition information, voice recognition information, biometric information (e.g., fingerprints or other unique biometric markers), or other information. In one embodiment, ID agent 322 identifies the observed individual via processing captured data. In one embodiment, ID agent 322 initially identifies the observed individual via an identifier, and then continues to identify that particular individual in captured video or audio based on identification information provided by the observed individual.

Policy module 324 enables controller 320 to access policy information for the observed individual. In one embodiment, a wearable device of the observed individual sends the policy information to sensor 310/controller 320 via a wireless link with the sensor system. Thus, policy module 324 can include driver mechanisms and/or service calls to access a wireless transceiver of the sensor system (not specifically shown). In one embodiment, controller 320 accesses a policy 352 from server 350 over network 340. Thus, policy module 324 can include driver mechanisms and/or service calls to access a wireless or wired transceiver of the sensor system (not specifically shown). Policy module 324 can further enable controller 320 to control operation of sensor 310 in accordance with the obtained policy. For example, controller 320 can further process the information received from sensor 310 based on what is indicated in the policy related to the observed individual. Server 350 can be a registry or database of policy information for individuals. Server 350 can be managed and/or operated by a commercial company, a private company, a federal agency, a regulatory body, a commercial entity authorized by a governmental agency, or some combination.

Recording manager 326 enables controller 320 to process and record captured data. Recording manager 326 operates in accordance with policy information that policy module 324 obtains for the observed individual. In one embodiment, controller 320 only captures the data temporarily in data repository 330, and then discards the data. In one embodiment, recording manager 326 can still record derived information even if it does not record captured data (raw data). In one embodiment, recording manager 326 enables controller 320 to record data (either raw or processed data) at a remote location. As illustrated, controller 320 can access server 360 and store data in repository 362 over network 340. In one embodiment, server 350 and server 360 are the same server. Thus, recording manager 326 can include driver mechanisms and/or service calls to a network interface to access devices on network 340. Network 340 can include a local or global network, or both.

Sharing manager 328 enables controller 320 to share captured data and/or derived data with the observed individual. Sharing manager 328 operates in accordance with policy information that policy module 324 obtains for the observed individual. Sharing manager 328 enables controller 320 to provide access to sensor data to the observed individual. In one embodiment, sharing manager 328 manages implementation of data sharing negotiated between the sensor system and the observed individual. Sharing manager 328 can control the providing of access by the observed individual to information related to the individual that has been captured and/or processed by sensor 310 and controller 320. In one embodiment, sharing manager 328 manages the exchange of data for some form of payment, such monetary payment or reciprocity by the observed individual to provide data back to the owner/wearer of sensor 310.

In one embodiment, the observed individual has an associated wearable device, indicated by wearable 370. Wearable 370 can include one or more sensors 372 (which could be comparable to sensor 310), controller 374 (which could be comparable to controller 320), and network interface 376. In one embodiment, network interface 376 enables wearable 370 to access a network (e.g., network 340) to access a policy associated with an individual within an environment of sensor(s) 372. In one embodiment, wearable 370 has associated storage data repository 378. Data repository 378 enables wearable 370 to store captured data, process the captured data, manage the data in accordance with a security policy associated with an individual, and/or share sensor data (either raw data or processed data).

FIG. 4 is a flow diagram of an embodiment of an example of a policy-based interaction between a sensor and an individual. The exchange represents any interaction between a sensor device and a wearable device of an observed individual in accordance with any embodiment described herein. The exchange is policy-based in that the interaction is governed by an observed individual's policy. The exchange can also be policy-based in the sense that interactions regarding identification and obtaining and following policy/recording policies can be performed in accordance with interaction rules. Such rules can be included in the configuration of the devices themselves, such as being configured to identify an observed individual, and configured to obtain and honor a policy for identified individuals.

Wearable A represents a wearable device system (including sensor(s), processing resources, and storage resources) of Person A, and wearable B represents a wearable device system (including sensor(s), processing resources, and storage resources) of Person B. Server 402 represents a resource of an external network from which Person A can obtain a third party recording policy for Person B (the observed individual). In one embodiment, Person B can provide the recording policy directly to Person A from one wearable device to another, which could eliminate the need to have server 402.

Assume that Person B is standing in a park or at some other location. A friend, Person A, approaches Person B. As Person A approaches, Person B comes within the environment of wearable A. In one embodiment, wearable B broadcasts identification message 412 to wearable A, which could be of the form: “I am Person B, ID 11546; my facial recognition parameters are {bc, 25, ff, 25 . . . }.” Wearable A receives the broadcast.

In one embodiment, wearable B also indicates a recording policy associated with Person B, which wearable A would also receive. Otherwise, wearable A generates request 414 to server 402 to obtain the privacy policy or third party recording policy of Person B. In one embodiment, request 414 could be of the form: My ID is 91332 (Person A's ID); GET policy for ID 44563 (Person B's ID). Server 402 receives and processes the request. Server 402 provides Person B's policy to wearable A. In one example, the policy could indicate the following: “Cannot store any data about me. Will pay $0.02 per live reading of my facial affect—happy, sad, etc. Will pay $0.10 for each photo of me smiling . . . .”

Person B talks with Person A. While they converse, wearable A captures and processes live video of Person B. Wearable A processes the data in accordance with the received policy. Thus, in one embodiment, wearable A sends derived mood information to wearable B during the conversation. The derived mood information can be derived facial affect data (how Person B is feeling as indicated by facial indicators). For example, wearable A can provide message 418 to indicate that Person B is mildly happy, message 420 to indicate a change of mood to indicate that Person B is sad, and message 422 to indicate that Person B is mildly happy again.

In one embodiment, wearable B can process and store the received information. For example, wearable B can tag or correlate the received mood information with stored biometric information and/or audio recording of the conversation. Thus, Person B could observe how different information affects him/her.

While the exchange is shown with respect to Person A obtaining Person B's policy, it will be understood that in the same conversation, wearable B could also obtain a policy related to Person A, and likewise process captured data based on Person A's policy. Other interactions are also possible. For example, assume a scenario in which Person B, via wearable B, requests, on-demand, data from Person A's wearable. Such an interaction could occur with wearable B sending a message to wearable A that indicates “measure my mood right now,” or “record video of what I just said.”

In one embodiment, wearable A could offer data to Person B via wearable B, when Person A or Person B behaves in a specific way. For example, wearable A could send a message to offer “Here's a photo of you laughing” or “here's the best/worst mood you exhibited in our current interaction.” Other possible examples could include sending a message to indicate “You behaved like a total jerk, and here's the video of it, along with my Galvanic Skin Response and pulse rate showing how offended I am.” Other examples include indicating from one wearable to another such things as “Here's a video of what you said to make me laugh,” or, “You looked into my eyes versus looking at my feet only 20% of the time you were talking to me.” Such interactions can be useful in behavior tracking and training, for example. It will be understood that there is not a restriction on the type of interactions that are possible.

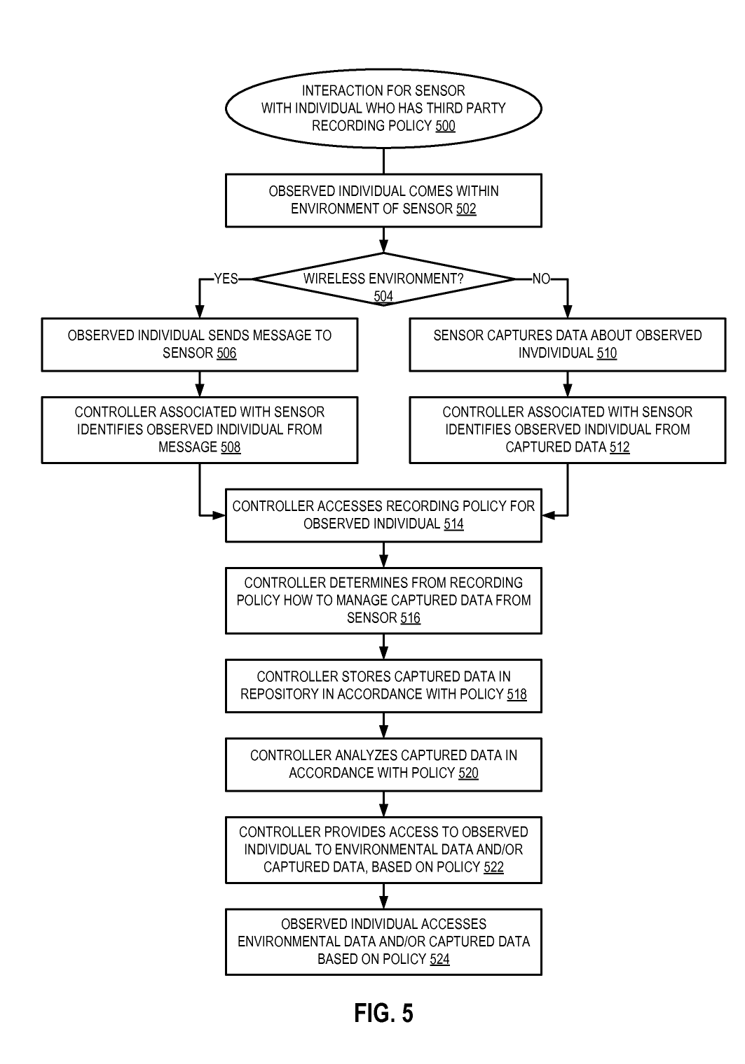

FIG. 5 is a flow diagram of an embodiment of a process for interaction between a sensor and an individual that has a third party recording policy. Process 500 starts when an individual comes within an environment of an environmental sensor, 502. The individual thus becomes an observed individual, seeing that the sensor can then detect and measure data about the individual. The environmental sensor can be a sensor in accordance with any embodiment described herein.

If the sensor is enabled for wireless communication, 504 YES branch, in one embodiment the observed individual sends a wireless message to the sensor, 506. The wireless message indicates at least an identity of the observed individual. In one embodiment, the message further provides other information. The message enables the sensor to access a policy for the observed individual. In one embodiment, the message includes the policy. In one embodiment, the message includes an identifier associated with the observed individual. In one embodiment, the controller associated with the sensor identifies the observed individual from the message, such as by the identifier provided, 508. The controller associated with the sensor can be part of the sensor itself, or can be a controller that receives and processes the captured data from the sensor.

If the sensor is not enabled for wireless communication, 504 NO branch, the sensor cannot receive an identifier from the observed individual. In such a case, in one embodiment the sensor can captures data about the observed individual, 510, and the controller can identify the observed individual from the captured data, 512. For example, the controller can use voice or facial recognition techniques based on information available from a database.

Whether in a wireless environment or not, the controller can then access the recording policy or privacy policy for the observed individual, 514. In one embodiment, the controller determines from the recording policy how to manage the captured data from the sensor, 516. In accordance with the policy, the controller may determine to not store the captured data. In one embodiment, the controller may determine to store the captured data in a repository, 518. In one embodiment, the controller may determine to analyze the captured data, and for example, derive mood information to provide to the observed individual, 520.

The controller provides access to the observed individual to the environmental data or the data from the sensor. The controller may provide access to the captured data itself and/or to environmental data or data that is processed or derived by the controller, 522. In one embodiment, the observed individual accesses the data based on the policy, 524. Accessing the data based on the policy can include the observed individual providing payment for the third party data.

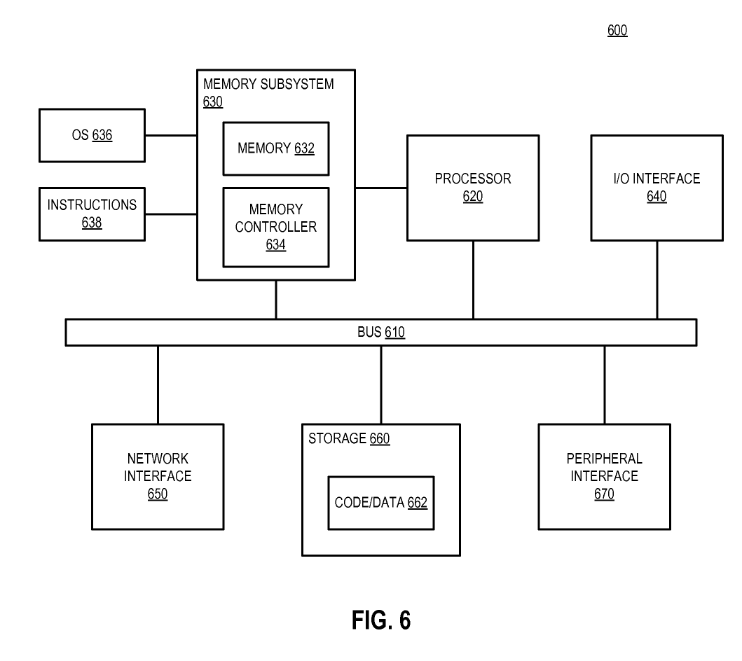

FIG. 6 is a block diagram of an embodiment of a computing system in which policy-based recording control can be implemented. System 600 represents a computing device in accordance with any embodiment described herein, and can be a laptop computer, a desktop computer, a server, a gaming or entertainment control system, a scanner, copier, printer, routing or switching device, or other electronic device. System 600 includes processor 620, which provides processing, operation management, and execution of instructions for system 600. Processor 620 can include any type of microprocessor, central processing unit (CPU), processing core, or other processing hardware to provide processing for system 600. Processor 620 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

Memory subsystem 630 represents the main memory of system 600, and provides temporary storage for code to be executed by processor 620, or data values to be used in executing a routine. Memory subsystem 630 can include one or more memory devices such as read-only memory (ROM), flash memory, one or more varieties of random access memory (RAM), or other memory devices, or a combination of such devices. Memory subsystem 630 stores and hosts, among other things, operating system (OS) 636 to provide a software platform for execution of instructions in system 600. Additionally, other instructions 638 are stored and executed from memory subsystem 630 to provide the logic and the processing of system 600. OS 636 and instructions 638 are executed by processor 620. Memory subsystem 630 includes memory device 632 where it stores data, instructions, programs, or other items. In one embodiment, memory subsystem includes memory controller 634, which is a memory controller to generate and issue commands to memory device 632.

Processor 620 and memory subsystem 630 are coupled to bus/bus system 610. Bus 610 is an abstraction that represents any one or more separate physical buses, communication lines/interfaces, and/or point-to-point connections, connected by appropriate bridges, adapters, and/or controllers. Therefore, bus 610 can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (commonly referred to as “Firewire”). The buses of bus 610 can also correspond to interfaces in network interface 650.

System 600 also includes one or more input/output (I/O) interface(s) 640, network interface 650, one or more internal mass storage device(s) 660, and peripheral interface 670 coupled to bus 610. I/O interface 640 can include one or more interface components through which a user interacts with system 600 (e.g., video, audio, and/or alphanumeric interfacing). Network interface 650 provides system 600 the ability to communicate with remote devices (e.g., servers, other computing devices) over one or more networks. Network interface 650 can include an Ethernet adapter, wireless interconnection components, USB (universal serial bus), or other wired or wireless standards-based or proprietary interfaces.

Storage 660 can be or include any conventional medium for storing large amounts of data in a nonvolatile manner, such as one or more magnetic, solid state, or optical based disks, or a combination. Storage 660 holds code or instructions and data 662 in a persistent state (i.e., the value is retained despite interruption of power to system 600). Storage 660 can be generically considered to be a “memory,” although memory 630 is the executing or operating memory to provide instructions to processor 620. Whereas storage 660 is nonvolatile, memory 630 can include volatile memory (i.e., the value or state of the data is indeterminate if power is interrupted to system 600).

Peripheral interface 670 can include any hardware interface not specifically mentioned above. Peripherals refer generally to devices that connect dependently to system 600. A dependent connection is one where system 600 provides the software and/or hardware platform on which operation executes, and with which a user interacts.

In one embodiment, system 600 further includes one or more sensors to capture data about an observed individual. Thus, system 600 could be a sensor system. As a sensor system, system 600 can capture data about an observed individual, and provide data to the individual based on a policy associated with the individual.

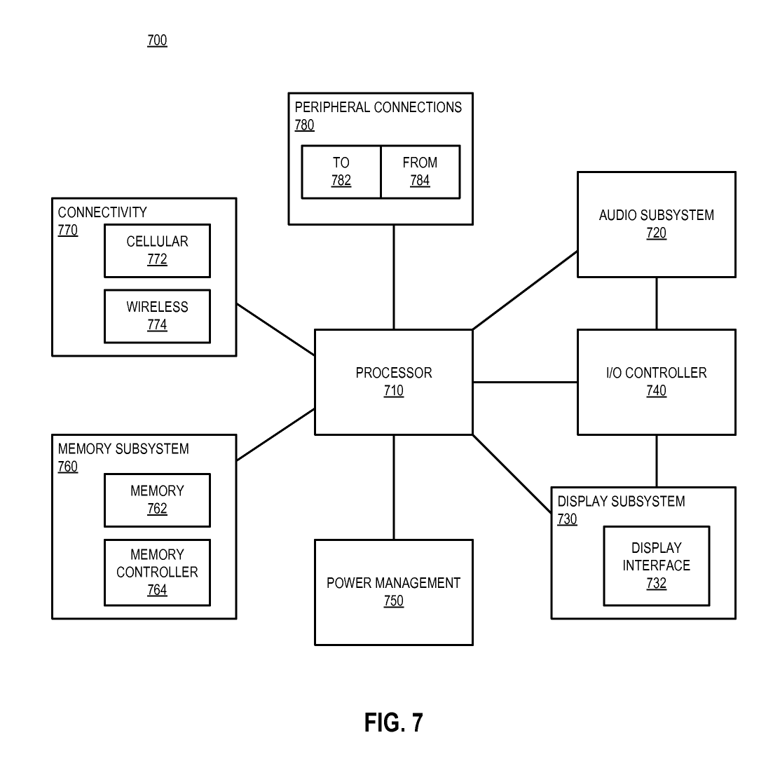

FIG. 7 is a block diagram of an embodiment of a mobile device in which policy-based recording control can be implemented. Device 700 represents a mobile computing device, such as a computing tablet, a mobile phone or smartphone, a wireless-enabled e-reader, wearable computing device, or other mobile device. It will be understood that certain of the components are shown generally, and not all components of such a device are shown in device 700.

Device 700 includes processor 710, which performs the primary processing operations of device 700. Processor 710 can include one or more physical devices, such as microprocessors, application processors, microcontrollers, programmable logic devices, or other processing means. In one embodiment, processor 710 includes optical interface components in addition to a processor die. The processing operations performed by processor 710 include the execution of an operating platform or operating system on which applications and/or device functions are executed. The processing operations include operations related to I/O (input/output) with a human user or with other devices, operations related to power management, and/or operations related to connecting device 700 to another device. The processing operations can also include operations related to audio I/O and/or display I/O.

In one embodiment, device 700 includes audio subsystem 720, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into device 700, or connected to device 700. In one embodiment, a user interacts with device 700 by providing audio commands that are received and processed by processor 710.

Display subsystem 730 represents hardware (e.g., display devices) and software (e.g., drivers) components that provide a visual and/or tactile display for a user to interact with the computing device. Display subsystem 730 includes display interface 732, which includes the particular screen or hardware device used to provide a display to a user. In one embodiment, display interface 732 includes logic separate from processor 710 to perform at least some processing related to the display. In one embodiment, display subsystem 730 includes a touchscreen device that provides both output and input to a user.

I/O controller 740 represents hardware devices and software components related to interaction with a user. I/O controller 740 can operate to manage hardware that is part of audio subsystem 720 and/or display subsystem 730. Additionally, I/O controller 740 illustrates a connection point for additional devices that connect to device 700 through which a user might interact with the system. For example, devices that can be attached to device 700 might include microphone devices, speaker or stereo systems, video systems or other display device, keyboard or keypad devices, or other I/O devices for use with specific applications such as card readers or other devices.

As mentioned above, I/O controller 740 can interact with audio subsystem 720 and/or display subsystem 730. For example, input through a microphone or other audio device can provide input or commands for one or more applications or functions of device 700. Additionally, audio output can be provided instead of or in addition to display output. In another example, if display subsystem includes a touchscreen, the display device also acts as an input device, which can be at least partially managed by I/O controller 740. There can also be additional buttons or switches on device 700 to provide I/O functions managed by I/O controller 740.

In one embodiment, I/O controller 740 manages devices such as accelerometers, cameras, light sensors or other environmental sensors, gyroscopes, global positioning system (GPS), or other hardware that can be included in device 700. The input can be part of direct user interaction, as well as providing environmental input to the system to influence its operations (such as filtering for noise, adjusting displays for brightness detection, applying a flash for a camera, or other features). In one embodiment, device 700 includes power management 750 that manages battery power usage, charging of the battery, and features related to power saving operation.

Memory subsystem 760 includes memory device(s) 762 for storing information in device 700. Memory subsystem 760 can include nonvolatile (state does not change if power to the memory device is interrupted) and/or volatile (state is indeterminate if power to the memory device is interrupted) memory devices. Memory 760 can store application data, user data, music, photos, documents, or other data, as well as system data (whether long-term or temporary) related to the execution of the applications and functions of system 700. In one embodiment, memory subsystem 760 includes memory controller 764 (which could also be considered part of the control of system 700, and could potentially be considered part of processor 710). Memory controller 764 includes a scheduler to generate and issue commands to memory device 762.

Connectivity 770 includes hardware devices (e.g., wireless and/or wired connectors and communication hardware) and software components (e.g., drivers, protocol stacks) to enable device 700 to communicate with external devices. The device could be separate devices, such as other computing devices, wireless access points or base stations, as well as peripherals such as headsets, printers, or other devices.

Connectivity 770 can include multiple different types of connectivity. To generalize, device 700 is illustrated with cellular connectivity 772 and wireless connectivity 774. Cellular connectivity 772 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), or other cellular service standards. Wireless connectivity 774 refers to wireless connectivity that is not cellular, and can include personal area networks (such as Bluetooth), local area networks (such as WiFi), and/or wide area networks (such as WiMax), or other wireless communication. Wireless communication refers to transfer of data through the use of modulated electromagnetic radiation or mechanical movement (for example, ultrasonic pressure waves) through a non-solid medium. Wired communication occurs through a solid communication medium.

Peripheral connections 780 include hardware interfaces and connectors, as well as software components (e.g., drivers, protocol stacks) to make peripheral connections. It will be understood that device 700 could both be a peripheral device (“to” 782) to other computing devices, as well as have peripheral devices (“from” 784) connected to it. Device 700 commonly has a “docking” connector to connect to other computing devices for purposes such as managing (e.g., downloading and/or uploading, changing, synchronizing) content on device 700. Additionally, a docking connector can allow device 700 to connect to certain peripherals that allow device 700 to control content output, for example, to audiovisual or other systems.

In addition to a proprietary docking connector or other proprietary connection hardware, device 700 can make peripheral connections 780 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other type.

In one embodiment, system 700 further includes one or more sensors to capture data about an observed individual. Thus, system 700 could be a sensor system. As a sensor system, system 700 can capture data about an observed individual, and provide data to the individual based on a policy associated with the individual.

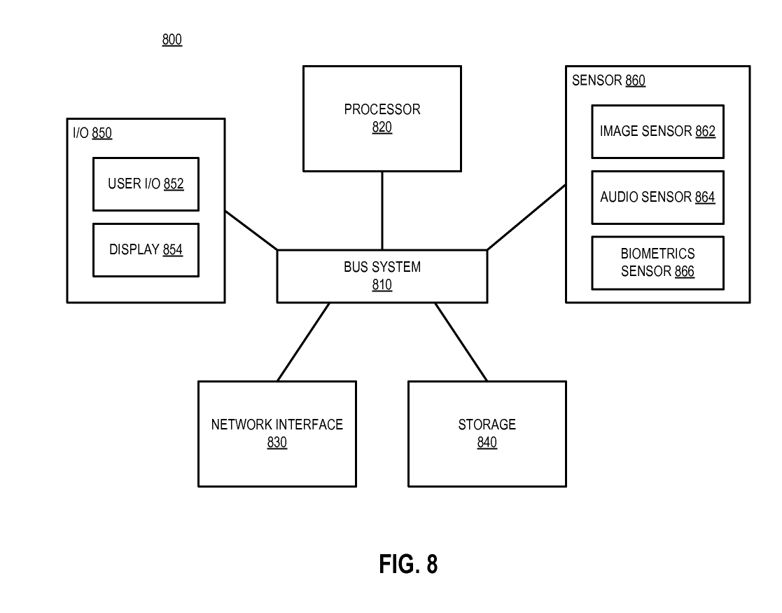

FIG. 8 is a block diagram of an embodiment of a wearable device in which policy-based recording control can be implemented. It will be understood that certain of the components are shown generally, and not all components of such a device are shown in device 800. Device 800 includes bus/bus system 810. Bus 810 is an abstraction that represents any one or more separate physical buses, communication lines/interfaces, and/or point-to-point connections, connected by appropriate bridges, adapters, and/or controllers.

Device 800 includes processor 820, which performs the primary processing operations of device 800. Processor 820 can include one or more physical devices, such as microprocessors, application processors, microcontrollers, programmable logic devices, or other processing means. The processing operations performed by processor 820 include the execution of an operating platform or operating system on which applications and/or device functions are executed. The processing operations include operations related to I/O (input/output) with a human user or with other devices, operations related to power management, and/or operations related to connecting device 800 to another device. The processing operations can also include operations related to audio I/O and/or display I/O.

Device 800 includes network interface 830, which includes hardware devices (e.g., wireless and/or wired connectors and communication hardware) and software components (e.g., drivers, protocol stacks) to enable device 800 to communicate with external devices. The external device could be separate devices, such as other computing devices, wireless access points or base stations, as well as peripherals such as headsets, printers, or other devices. Network interface 830 can allow any of a number of types of wireless connectivity, such as personal area networks, local area networks, and/or wide area networks.

In one embodiment, device 800 includes storage 840. Storage 840 can include nonvolatile and/or volatile memory devices. Storage 840 allows device 800 to store application data, user data, music, photos, videos, documents, or other data, as well as system data (whether long-term or temporary) related to the execution of the functions of system 800.

I/O controller 850 represents hardware devices and software components related to interaction with a user. I/O controller 850 can operate to manage hardware that allows a user to provide input into system 800, as well as to provide a display to the user. Thus, I/O includes user I/O 852 and display 854.

In one embodiment, device 800 includes sensor 860, which can include one or more different sensors. Sensor 860 can include image sensor 862, which can capture still and/or video. Sensor 860 can include audio sensor 864, which can capture audio. Sensor 860 can include biometric sensor 866, which can be any of a variety of sensors that measure biometric information of the wearer, such as pulse, heart rate, galvanic skin response, temperature, or other information.

In one embodiment, system 800 measures data about a user-wearer, and exchanges data with other environmental sensors that the wearer encounters. For example, processor 820 can trigger network interface 830 to send a message to a third party sensor, and negotiate interaction between the devices. In particular, system 800 can negotiate for the third party device to comply with a policy associated with the wearer, in accordance with any embodiment described herein.

In one aspect, a method for providing access to captured data includes receiving, by a processor device, data from an environmental sensor that captures data about an observed individual, wherein the processor device is controlled by an entity other than the observed individual; identifying the observed individual by the processor device; accessing a digital third party recording policy associated with the observed individual, the policy indicating a type of environmental data the observed individual is interested in receiving from third parties; and providing access by the processor device to the observed individual to the environmental data in accordance with the associated policy.

In one embodiment, receiving the data comprises receiving video information. In one embodiment, receiving the data comprises receiving audio information. In one embodiment, identifying the observed individual comprises receiving an identification from the observed individual that identifies the observed individual. In one embodiment, identifying the observed individual comprises identifying the observed individual from data captured about the observed individual. In one embodiment, accessing the third party recording policy comprises receiving the third party recording policy directly from the observed individual. In one embodiment, accessing the third party recording policy comprises obtaining the third party recording policy from a remote database. In one embodiment, providing access to the environmental data comprises sending the environmental data to a wearable device of the observed individual. In one embodiment, providing access to the environmental data comprises providing the environmental data to the observed individual in exchange for compensation from the observed individual. In one embodiment, providing access to the environmental data comprises providing the environmental data to the observed individual in exchange for environmental data from the observed individual. In one embodiment, providing access to the environmental data comprises providing mood information derived from the captured data.

In one aspect, an article of manufacture comprising a computer readable storage medium having content stored thereon, which when executed causes a device to perform operations including receiving, by a processor device, data from an environmental sensor that captures data about an observed individual, wherein the processor device is controlled by an entity other than the observed individual; identifying the observed individual by the processor device; accessing a digital third party recording policy associated with the observed individual, the policy indicating a type of environmental data the observed individual is interested in receiving from third parties; and providing access by the processor device to the observed individual to the environmental data in accordance with the associated policy.

In one embodiment, the content for receiving the data comprises content for receiving video information. In one embodiment, the content for receiving the data comprises content for receiving audio information. In one embodiment, the content for identifying the observed individual comprises content for receiving an identification from the observed individual that identifies the observed individual. In one embodiment, the content for identifying the observed individual comprises content for identifying the observed individual from data captured about the observed individual. In one embodiment, the content for accessing the third party recording policy comprises content for receiving the third party recording policy directly from the observed individual. In one embodiment, the content for accessing the third party recording policy comprises content for obtaining the third party recording policy from a remote database. In one embodiment, the content for providing access to the environmental data comprises content for sending the environmental data to a wearable device of the observed individual. In one embodiment, the content for providing access to the environmental data comprises content for providing the environmental data to the observed individual in exchange for compensation from the observed individual. In one embodiment, the content for providing access to the environmental data comprises content for providing the environmental data to the observed individual in exchange for environmental data from the observed individual.

In one aspect, an apparatus for providing access to captured data includes means for receiving data from an environmental sensor that captures data about an observed individual, wherein the environmental sensor is controlled by an entity other than the observed individual; means for identifying the observed individual; means for accessing a digital third party recording policy associated with the observed individual, the policy indicating a type of environmental data the observed individual is interested in receiving from third parties; and means for providing access to the observed individual to the environmental data in accordance with the associated policy.

In one embodiment, the means for receiving the data comprises means for receiving video information. In one embodiment, the means for receiving the data comprises means for receiving audio information. In one embodiment, the means for identifying the observed individual comprises means for receiving an identification from the observed individual that identifies the observed individual. In one embodiment, the means for identifying the observed individual comprises means for identifying the observed individual from data captured about the observed individual. In one embodiment, the means for accessing the third party recording policy comprises means for receiving the third party recording policy directly from the observed individual. In one embodiment, the means for accessing the third party recording policy comprises means for obtaining the third party recording policy from a remote database. In one embodiment, the means for providing access to the environmental data comprises means for sending the environmental data to a wearable device of the observed individual. In one embodiment, the means for providing access to the environmental data comprises means for providing the environmental data to the observed individual in exchange for compensation from the observed individual. In one embodiment, the means for providing access to the environmental data comprises means for providing the environmental data to the observed individual in exchange for environmental data from the observed individual.

In one aspect, a wearable device that provides access to captured data includes an environmental sensor to capture data about an observed individual that is within an environment of the environmental sensor, wherein the wearable device is controlled by an entity other than the observed individual; wireless network hardware to connect to a wireless network; and a processor device to receive captured data from the environmental sensor, the processor device to identify the observed individual, access a digital third party recording policy associated with the observed individual over the wireless network, and provide access to the observed individual to the captured data in accordance with the associated policy via the wireless network, wherein the associated policy indicates a type of environmental data the observed individual is interested in receiving from third parties.

In one embodiment, the environmental sensor is to capture video information. In one embodiment, the environmental sensor is to capture audio information. In one embodiment, the processor device is to identify the observed individual by receiving identification information via the wireless network from the observed individual that identifies the observed individual. In one embodiment, the processor device is to identify the observed individual by identifying the observed individual from data captured about the observed individual. In one embodiment, the processor device is to access the third party recording policy by receiving the third party recording policy directly from the observed individual via the wireless network. In one embodiment, the processor device is to access the third party recording policy by obtaining the third party recording policy from a remote database via the wireless network. In one embodiment, the processor device is to provide access to the environmental data by sending the environmental data to a wearable device of the observed individual via the wireless network. In one embodiment, the processor device is to provide access to the environmental data by providing the environmental data to the observed individual in exchange for compensation from the observed individual. In one embodiment, the processor device is to provide access to the environmental data by providing the environmental data to the observed individual in exchange for environmental data from the observed individual.

In one aspect, a system in which an observed individual receives access to data related to the observed individual as captured by an environmental sensor includes a wearable device of an observed individual, wherein the wearable device includes wireless network hardware to connect to one or more wireless networks; and an environmental sensor controlled by an entity other than the observed individual to capture data about the observed individual, the environmental sensor not part of the wearable device of the observed individual, and including network interface hardware to connect to a network; and a processor device to receive captured data from the environmental sensor, the processor device to identify the observed individual, access a digital third party recording policy associated with the observed individual over the wireless network, and provide access to the observed individual to the captured data in accordance with the associated policy via the wireless network, wherein the associated policy indicates a type of environmental data the observed individual is interested in receiving from third parties.

In one embodiment, the environmental sensor is to capture video information. In one embodiment, the environmental sensor is to capture audio information. In one embodiment, the environmental sensor comprises a wearable device of the entity other than the observed individual. In one embodiment, the processor device is to identify the observed individual by receiving identification information from the wearable device. In one embodiment, the processor device is to identify the observed individual by identifying the observed individual from data captured about the observed individual, including information obtained via the network interface hardware. In one embodiment, the processor device is to receive the third party recording policy directly from the wearable device. In one embodiment, the processor device is to access the third party recording policy by obtaining the third party recording policy from a remote database via the network interface hardware. In one embodiment, the processor device is to provide access to the environmental data by sending the environmental data to the wearable device.

Flow diagrams as illustrated herein provide examples of sequences of various process actions. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope. Therefore, the illustrations and examples herein should be construed in an illustrative, and not a restrictive sense. The scope of the invention should be measured solely by reference to the claims that follow.

Some embodiments pertain to Example 1 that includes a method for providing access to captured data. The method includes a processor device receiving data from an environmental sensor that captures data about an observed individual, wherein the processor device is controlled by an entity other than the observed individual, identifying the observed individual by the processor device, accessing a digital third party recording policy associated with the observed individual, the policy indicating a type of environmental data the observed individual is interested in receiving from third parties and providing access by the processor device to the observed individual to the environmental data in accordance with the associated policy.

Example 2 includes the subject matter of Example 1, and wherein receiving the data comprises receiving video information.

Example 3 includes the subject matter of Examples 1 or 2, and wherein receiving the data comprises receiving audio information.

Example 4 includes the subject matter of Examples 1 to 3, and wherein identifying the observed individual comprises receiving an identification from the observed individual that identifies the observed individual.

Example 5 includes the subject matter of Examples 1 to 3, and wherein identifying the observed individual comprises identifying the observed individual from data captured about the observed individual.

Example 6 includes the subject matter of Examples 1 to 5, and wherein accessing the third party recording policy comprises receiving the third party recording policy directly from the observed individual.

Example 7 includes the subject matter of Examples 1 to 5, and wherein accessing the third party recording policy comprises obtaining the third party recording policy from a remote database.

Example 8 includes the subject matter of Examples 1 to 7, and wherein providing access to the environmental data comprises sending the environmental data to a wearable device of the observed individual.

Example 9 includes the subject matter of Examples 1 to 8, and wherein providing access to the environmental data comprises providing the environmental data to the observed individual in exchange for compensation from the observed individual.

Example 10 includes the subject matter of Examples 1 to 8, and wherein providing access to the environmental data comprises providing the environmental data to the observed individual in exchange for environmental data from the observed individual.

Example 11 includes the subject matter of Examples 1 to 10, and wherein providing access to the environmental data comprises providing mood information derived from the captured data.

Example 12 includes the subject matter of Examples 1 to 11, and further comprising enforcing recording or processing restrictions indicated by the policy.

Some embodiments pertain to Example 13 that includes an article of manufacture comprising a computer readable storage medium having content stored thereon, which when executed causes a device to perform a method in accordance with any of claims 1 to 12.

Some embodiments pertain to Example 14 that includes an apparatus for providing access to captured data, comprising means for performing a method in accordance with any of claims 1 to 12.

Some embodiments pertain to Example 15 that includes a wearable device that provides access to captured data. The wearable device includes comprising an environmental sensor to capture data about an observed individual that is within an environment of the environmental sensor, wherein the wearable device is controlled by an entity other than the observed individual, wireless network hardware to connect to a wireless network and a processor device to receive captured data from the environmental sensor, the processor device to identify the observed individual, access a digital third party recording policy associated with the observed individual over the wireless network, and provide access to the observed individual to the captured data in accordance with the associated policy via the wireless network, wherein the associated policy indicates a type of environmental data the observed individual is interested in receiving from third parties.

Example 16 includes the subject matter of Example 15, and wherein the environmental sensor is to capture video information or audio information.

Example 17 includes the subject matter of Example 15, and wherein the processor device is to identify the observed individual by receiving identification information via the wireless network from the observed individual that identifies the observed individual.

Example 18 includes the subject matter of Example 15, and wherein the processor device is to identify the observed individual by identifying the observed individual from data captured about the observed individual.

Example 19 includes the subject matter of Example 15, and wherein the processor device is to access the third party recording policy by receiving the third party recording policy directly from the observed individual via the wireless network.

Example 20 includes the subject matter of Example 15, and wherein the processor device is to access the third party recording policy by obtaining the third party recording policy from a remote database via the wireless network.

Example 21 includes the subject matter of Example 15, and wherein the processor device is to provide access to the environmental data by sending the environmental data to a wearable device of the observed individual via the wireless network.

Example 22 includes the subject matter of Example 15, and wherein the processor device is to provide access to the environmental data by providing the environmental data to the observed individual in exchange for environmental data from the observed individual.

Some embodiments pertain to Example 23 that includes a system in which an observed individual receives access to data related to the observed individual as captured by an environmental sensor. The system includes a wearable device of an observed individual, wherein the wearable device includes wireless network hardware to connect to one or more wireless networks and an environmental sensor controlled by an entity other than the observed individual to capture data about the observed individual. The environmental sensor is not part of the wearable device of the observed individual and includes network interface hardware to connect to a network and a processor device to receive captured data from the environmental sensor, the processor device to identify the observed individual, access a digital third party recording policy associated with the observed individual over the wireless network, and provide access to the observed individual to the captured data in accordance with the associated policy via the wireless network, wherein the associated policy indicates a type of environmental data the observed individual is interested in receiving from third parties.

Example 24 includes the subject matter of Example 23, and wherein the environmental sensor comprises a wearable device of the entity other than the observed individual.

Example 25 includes the subject matter of Example 23, and wherein the processor device is to identify the observed individual by identifying the observed individual from data captured about the observed individual, including information obtained via the network interface hardware.

1-25. (canceled)

26. A method comprising:
receiving, by a processor device, data from an environmental sensor that captures data about an observed individual, wherein the processor device is controlled by an entity other than the observed individual;
identifying the observed individual by the processor device;
accessing a digital third party recording policy associated with the observed individual, the policy indicating a type of environmental data the observed individual is interested in receiving from third parties; and
providing access by the processor device to the observed individual to the environmental data in accordance with the associated policy.

27. The method of claim 26, wherein receiving the data comprises:
receiving video information.

28. The method of claim 26, wherein receiving the data comprises:
receiving audio information.

29. The method of claim 26, wherein identifying the observed individual comprises:
receiving an identification from the observed individual that identifies the observed individual.

30. The method of claim 26, wherein identifying the observed individual comprises:
identifying the observed individual from data captured about the observed individual.

31. The method of claim 26, wherein accessing the third party recording policy comprises:
receiving the third party recording policy directly from the observed individual.

32. The method of claim 26, wherein accessing the third party recording policy comprises:
obtaining the third party recording policy from a remote database.

33. The method of claim 26, wherein providing access to the environmental data comprises:
sending the environmental data to a wearable device of the observed individual.

34. The method of claim 26, wherein providing access to the environmental data comprises:
providing the environmental data to the observed individual in exchange for compensation from the observed individual.

35. The method of claim 26, wherein providing access to the environmental data comprises:
providing the environmental data to the observed individual in exchange for environmental data from the observed individual.

36. An article of manufacture comprising a computer readable storage medium having content stored thereon, which when executed causes a device to perform operations including:
receiving, by a processor device, data from an environmental sensor that captures data about an observed individual, wherein the processor device is controlled by an entity other than the observed individual;
identifying the observed individual by the processor device;
accessing a digital third party recording policy associated with the observed individual, the policy indicating a type of environmental data the observed individual is interested in receiving from third parties; and
providing access by the processor device to the observed individual to the environmental data in accordance with the associated policy.

37. The article of manufacture of claim 36, wherein the content for receiving the data comprises content for
receiving video information or audio information.

38. The article of manufacture of claim 36, wherein the content for identifying the observed individual comprises content for
receiving an identification from the observed individual that identifies the observed individual.

39. The article of manufacture of claim 36, wherein the content for accessing the third party recording policy comprises content for
receiving the third party recording policy directly from the observed individual.

40. The article of manufacture of claim 36, wherein the content for providing access to the environmental data comprises content for
sending the environmental data to a wearable device of the observed individual.

41. A wearable device comprising:
an environmental sensor to capture data about an observed individual that is within an environment of the environmental sensor, wherein the wearable device is controlled by an entity other than the observed individual;
wireless network hardware to connect to a wireless network; and
a processor device to receive captured data from the environmental sensor, the processor device to identify the observed individual, access a digital third party recording policy associated with the observed individual over the wireless network, and provide access to the observed individual to the captured data in accordance with the associated policy via the wireless network, wherein the associated policy indicates a type of environmental data the observed individual is interested in receiving from third parties.

42. The wearable device of claim 41, wherein the environmental sensor is to capture video information or audio information.

43. The wearable device of claim 41, wherein the processor device is to identify the observed individual by receiving identification information via the wireless network from the observed individual that identifies the observed individual.

44. The wearable device of claim 41, wherein the processor device is to access the third party recording policy by receiving the third party recording policy directly from the observed individual via the wireless network.

45. The wearable device of claim 41, wherein the processor device is to provide access to the environmental data by sending the environmental data to a wearable device of the observed individual via the wireless network.
